(19) United States
(12) Patent Application Publication
(10) Pub. No.: US 2022/0343337 A1
(43) Pub. Date: Oct. 27, 2022

(54) METHOD IMPLEMENTED IN COMPUTER PROGRAM FOR VERIFICATION OF CONFORMITY AND/OR AUTHENTICITY OF AN ARTICLE

(71) Applicant: Carlos Eduardo Bernini KAPINS, Valinhos (BR)

(72) Inventor: Carlos Eduardo Bernini KAPINS, Valinhos (BR)

(21) Appl. No.: 17/541,697

(22) Filed: Dec. 3, 2021

(30) Foreign Application Priority Data
Apr. 27, 2021 (BR) BR1020210079835

(51) Int. Cl. G06Q 30/00; G06K 19/06

(52) U.S. Cl. CPC G06Q 30/018; G06K 19/06093

(57) ABSTRACT

A method implemented in a computer program for verifying the conformity and/or authenticity of an article is described, which comprises assigning a pair of random codes (C1) and (C2) to a given article (A), and the linkage of the codes to the article is stored in a database (BD1) accessed through an application and one of the codes being illegible only with the violation of the primary packaging (Pp), so that the verification of authenticity or conformity of the article (A) is obtained when the validity of the codes and the association of the pair of codes are verified. Through this basic functionality, it is possible to assign an article to an entity (E), without the risk of duplication; to control the number of times an article is reused, in accordance with legal and safety standards and to prevent reprocessing of the product, when necessary.

### CROSS-REFERENCE TO RELATED APPLICATIONS

The present application claims priority benefit of Brazil Application No. BR 10 2021 007983 5, filed Apr. 27, 2021, which application is hereby incorporated herein by reference in its entirety.

### TECHNICAL FIELD

The present patent invention describes a method implemented in a computer program to verify the conformity and/or authenticity of an article. More specifically, it comprises the assignment of a pair of random codes to a given article, with the linkage of the codes to the article stored in a database accessed through an application, and one of the codes being illegible only with the violation of the primary packaging, so that the authenticity or conformity verification of the article is obtained when the validity of the codes and the association of the pair of codes are verified. Through this basic functionality, it is possible to assign an article to an entity, without the risk of duplication; to control the number of times an item is reused, in compliance with legal and safety standards, and to prevent reprocessing of the product, when necessary.

### BACKGROUND OF THE INVENTION

Industrialized products are identified and priced through a means of marking that allows the retrieval of various information about the item, including brand, descriptions and various tax information. This coding, graphically represented through a bar code or QRCode, is usually displayed on the product packaging and facilitates commercial transactions. As an example, the GTIN, an acronym for Global Trade Item Number, is cited, an identifier for commercial items developed and controlled by GS1, and which comprises a code assigned to any item (product or service) that can be priced, ordered or billed at any point in the supply chain.

Despite being a necessary and important codification for commercial and logistical management, some articles receive a second codification for registration in specific databases. A typical example is medical articles (inputs and tools), whose records in inventory control databases require the generation of an alternative code, entered manually or digitally, in order to allow the reimbursement of the health insurer and/or the accounting of expenses for the proper accounting closing.

This re-registration of articles and the generation of a second coding generates rework, data typing and the need for human conference, with the sole purpose of accounting for expenses and managing the inventory.

The prior art describes the use of a coding displayed on an avatar (such as a barcode, QRCode, chip) for tracking commercial items, allowing for inventory and inventory control.

In the case of articles that have interchangeable parts or where specific issues must be controlled, such as the safe amount of reuses, avatars are provided that allow you to do this control in an intelligent way, wherein chips allow or not the coupling of a tool to a device (if the tool is not the original one) or identify the amount of reuse of a given article, the sterilization events, the identification of the user who handles it, among others.

The document US2019274782 describes a medical instrument that includes a body with an identification mark associated with predetermined information including a two-dimensional code and a GS1 code, which allows you to obtain predetermined information about the medical instrument, for example, an upper limit value of the use of the medical instrument body, the count of the use of the medical instrument body, the date and time of use of the medical instrument, a name of the operator using medical instrument body, etc.

Document KR102001535 describes a system for automatically reporting the records of drug or medical device delivery which comprises: a terminal including an input unit including any of a barcode reader, a QR code reader or an RFID reader; a QR code reader or an RFID reader; and a web server, which reports in detail the delivery of drugs or medical devices to a target server based on information received from the input unit, wherein the web server comprises: a scanner input processing module receiving numbers or characters from the input unit and the scanner; a user profile including an existing transaction database for storing existing user terminal transactions and a customer database for storing customer information recorded on the user terminal.

The document CN108446753 describes a method and system to encode a two-dimensional code of a good. By acquiring the GTIN code of the good to be coded and the information on the good to be coded; the information of good is coded to obtain the information on coding of good, wherein the information on coding of good includes the unique identification code of the good to be encoded; the GTIN code and information on coding of good undergoes a QR code encoding process to generate a QR code corresponding to the good to be encoded.

Document CN105184515 describes a cloud asset information management system comprising a product information server, a corporate asset server, a client and a corporate asset product, wherein a barcode, a two-dimensional code, or an RFID (Radio Frequency Identification Devices) tag, the GTIN (Global Trade Item Number) recording product is posted on the company's asset product; the product information server comprises hardware and a web service; a user authentication function is provided to a client by the web service; product assignment information is provided to the user according to the product's GTIN; the corporate asset server comprises hardware, a SQL (Structured Query Language) database service, and a cloud asset application service; user authentication functions, asset product addition, asset product view, asset product statistics and asset product search are provided by the SQL database service and the cloud asset application service.

Document US2018353256 describes a system and method for recording events that occur during a medical procedure, including events associated with the inventory of items used during the procedure.

The document US2007198357 describes a system and/or method to manage patients and products used in the treatment of their sleep-disordered breathing (SDB). A barcode reader preferably scans product data and wirelessly communicates it to a database for use in an inventory management system to track and generate product and patient information for the treatment of Obstructive Sleep Apnea (OSA), for example, for the treatment of Obstructive Sleep Apnea (OSA), for example, when receiving items in stock, distributing products, returning borrowed, rented and/or defective products, etc.

Document U.S. Pat. No. 5,602,377 describes a barcode reading and labeling apparatus for scanning and decoding a barcode associated with a product and generating a two-dimensional barcode data form incorporating selected data, including at least a portion of the decoded data related to the product of the product's barcode and additional data related to the product. The apparatus includes a microprocessor having data selection circuitry adapted to retrieve the selected data and to assemble the selected retrieved data into a format suitable for encoding. A method of providing a modified barcode data form using the apparatus is also available. The method steps includes: reading and decoding a product's barcode data form; select data to understand the modified barcode data form, the selected data including decoded data related to the product and additional data related to the product; and use the selected data to produce the modified barcode data form.

Document U.S. Pat. No. 5,732,401 describes a system for tracking costs of medical procedures by monitoring the movements of personnel, supplies and equipment and processing data on those movements to produce detailed and accurate accounting records of costs associated with specific services provided. Transponder tags are associated with each person and object for which costs must be tracked. Detected tag movements are combined with schedule, procedure, and cost information to build detailed records of activities and their costs in a way that allows for a wide variety of statistical and other analyses.

The state of the art describes systems and methods that allow tracking of products by reading associated codes. However, the linkage of a particular article to a user remains manually or digitally, with the consequent insecurities in the linkage process with regard to the possibility of fraud, for example.

Thus, the object of the present invention patent is a method implemented in a computer program to verify the conformity and/or authenticity of an article, a pair of random codes being assigned to a given article, with the linkage of codes to the article stored in a database accessed through an application, and one of the codes being illegible only with the violation of the primary packaging, so that the authenticity or conformity verification of the article is obtained when the validity of the codes and the association of the pair of codes are verified.

### SUMMARY

Characteristic of the invention is a method for a method for verifying the conformity and/or authenticity of an article that allows preventing the reprocessing of the product, if this is not possible, by blocking the second code associated with the article.

Characteristic of the invention is a method for verifying the conformity and/or authenticity of an article that allows, in the event that the article is capable of reprocessing, that the second code associated with the article allows to control the number of reprocesses and, when the limit is reached, the second code is blocked.

Characteristic of the invention is a method for verifying the conformity and/or authenticity of an article that allows tracking the use of articles, such as medical supplies.

Characteristic of the invention is a method for verifying the conformity and/or authenticity of an article that allows relating the articles linked to an entity, such as medical supplies used in a procedure for a given patient.

Characteristic of the invention is a method for verifying the conformity and/or authenticity of an article that prevents the assignment of the same article to a second patient, when the article is not reusable.

Characteristic of the invention is a method for verifying the conformity and/or authenticity of an article that allows the traceability of the article from production to its final use or disposal.

Characteristic of the invention is a method for verifying the conformity and/or authenticity of an article that allows the legibility of the code associated with the article only when the primary packaging is violated, thus preventing access prior to opening the packaging.

Characteristic of the invention is a method for verifying the conformity and/or authenticity of an article, and only after the association of the pair of codes is it possible to assign it to an entity.

### BRIEF DESCRIPTION OF THE FIGURES

FIG. 1 shows the flowchart of code pair generation and linkage to the article.

FIG. 2 shows the flowchart of verifying the association of the primary (C1) and secondary (C2) code pair.

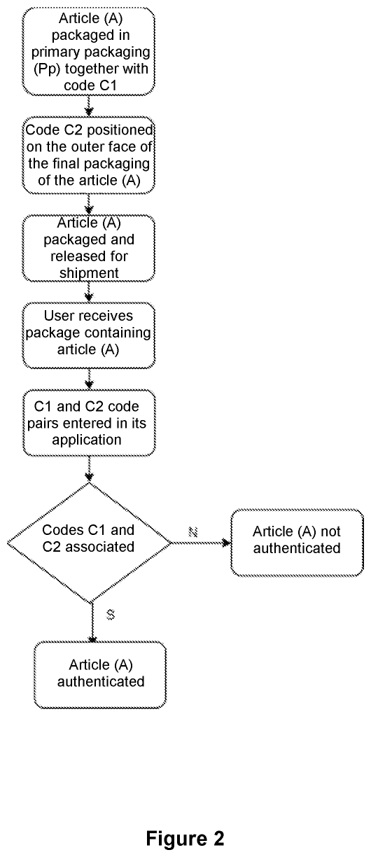

FIG. 3 shows the flowchart of attribute analysis linked to the primary (C1) and secondary (C2) codes.

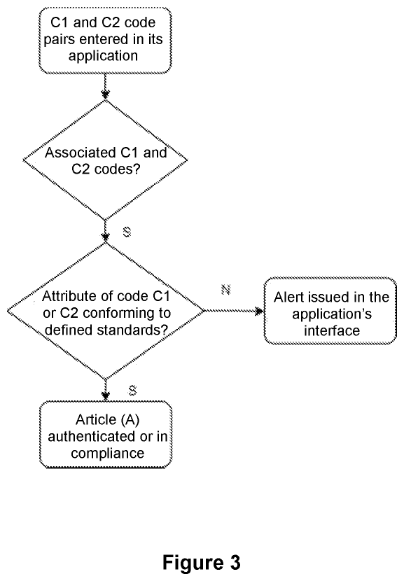

FIG. 4 shows the flowchart of assignment of the article (A) to an entity (E).

FIG. 5 shows the flowchart of the embodiment, in which only the primary code (C1) is linked to an article (A).

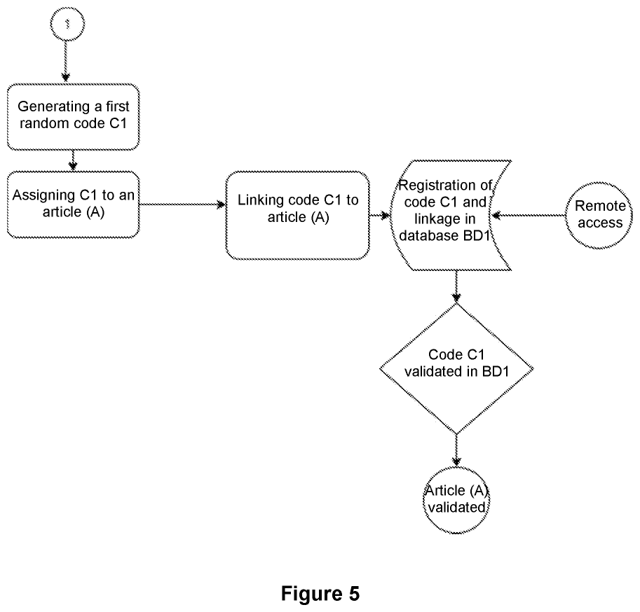

FIG. 6 shows the control flowchart of the number of linkages of a reusable article (A) to an entity (E).

FIG. 7 shows the flowchart of the registration of reprocessing and generation of a new primary code (C1) for a reprocessable article.

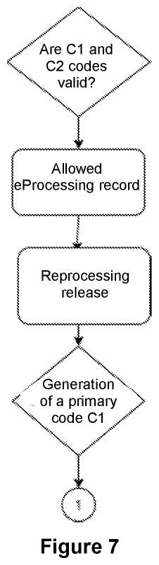

### DETAILED DESCRIPTION OF THE INVENTION

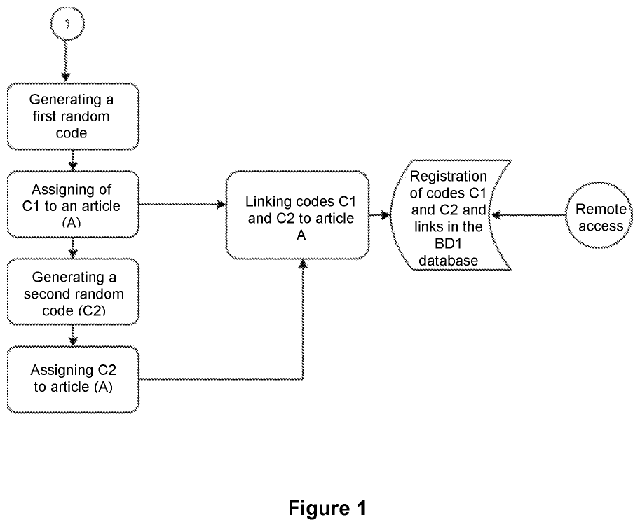

The method implemented in a computer program to verify the conformity and/or authenticity of an article, object of this patent of invention, comprises the assignment of a pair of different random codes (C1 and C2) to an article (A), said primary (C1) and secondary (C2) codes linked to each other and to the article (A), in one-to-one correspondence, in a database (BD1) accessed remotely through the world wide web through a mobile device or desktop equipped of an application, as shown in FIG. 1.

The random codes (C1) and (C2) are generated through an algorithm, and comprise a standardized data structure in numerical, alpha-numeric, two-dimensional form (barcode, QRCode), among others.

Optionally, a first code (C1) is generated using a proprietary computer program and a second code (C2) is generated using a commercial computer program, such as the unique encodings for identifying commercial items displayed on the product and/or product packaging, in a place visible to the user, which can be in the form of a barcode (EAN-13 codes), EAN/UPC barcodes, GS1 DataBar barcodes, QRCode, among others.

The first code (C1) is kept inaccessible to human vision or reading by a reader device, being readable only when there is violation of the primary packaging (Pp) that holds the article (A).

Optionally, the first code (C1) is printed/engraved onto an avatar (B) (such as a QR Code, barcode, or similar).

Optionally, the avatar (B) is coated with scratchable paint, requiring the removal of the coating to read the data structure.

Optionally, the first code (C1) is printed/engraved on the surface of the article (A).

The second code (C2) is kept apparent on the outside of the final packaging of the article (A), just like the conventional codes used in the tracking and logistics operations of commercial items.

Optionally, the second code (C2) is printed/engraved on an avatar (B) (such as a QR Code, barcode, or similar).

If the packaging (Pp) contains more than one item (A), each item (A) receives a first code (C1) in turn linked to a second code (C2) arranged on the external face of the packaging. In this situation, the secondary code C2 contains a linked attribute that allows to control the number of primary codes (C1) linked to secondary codes (C2).

The final packaging of the item (A) is the packaging that will be used for the shipment of the item (A), which may be the primary packaging (Pp) or a secondary packaging that holds the primary packaging (Pp).

The user who receives the article (A) accesses an application installed on a mobile device or stored in the cloud and informs the pair of codes (C1) and (C2). The secondary code (C2) is readable on the external face of the final packaging and the first code is readable upon violation of the primary packaging (Pp) of the article (A).

By “inform” is meant typing in a specific field of the application's graphical interface and/or reading the data structure through a reader device.

The pair of codes (C1) and (C2) informed in the application is analyzed based on the execution of an instruction stored in the computer program installed in a processor. If the pair of codes (C1) and (C2) is valid and the linkage in the database (BD1) is verified, a message is returned in the application interface informing the compliance or authenticity status of the article (A). If the linkage of the primary (C1) and secondary (C2) codes is not verified and/or the linkage of the codes (C1) and (C2) is not verified, an error message is returned.

Attributes can be linked to any of the primary (C1) or secondary (C2) codes, these attributes can be verified by the computer program at the time of linkage analysis, and the verification can be interrupted when an attribute does not comply with instructions previously stored in the computer program. For example, if an attribute is “expiration date”, the linkage operation is suspended if the computer program finds that the attribute's date is less than the reading date.

This first computerized module is particularly useful for indicating to a user the authenticity of an article (A), preventing piracy and ensuring security.

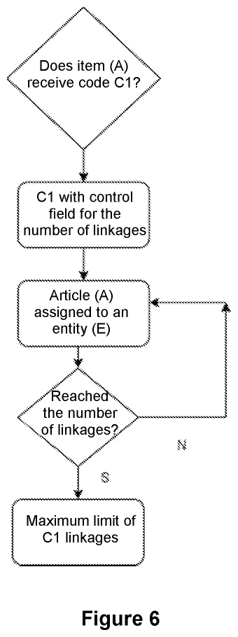

Alternatively, as shown in FIG. 6, a primary random code (C1) assigned and linked to an article (A) is generated, being registered in the database (BD1) accessed remotely through the world wide web through a mobile device equipped with an application.

The primary random code (C1) is kept inaccessible to human vision or reading by a reader device, being readable only with violation of the primary packaging (Pp) that holds the article (A).

The user receiving the article (A) accesses an application installed on an electronic device (such as a mobile phone, tablet, computer, laptop) and informs the application of the primary random code (C1) obtained by violating the primary packaging (Pp) of the article (A). The computer program verifies the validity of the primary code (C1), from a database verification (BD1), and returns an authenticity confirmation message. If the primary code (C1) is not valid, after verifying the database (BD1), an error message is returned.

A second computerized module associated with the first computerized module allows, from the verification of conformity or authenticity of an article (A), the article (A) to be associated with an entity (E), without the risk of duplication.

For example, in the case of assigning an article (A) to an entity (E) (in this case, a patient), a user registered in the application informs, in a specific field of the graphic interface, the codes (C1) and (C2) linked to the article (A). To obtain code C1, the user must necessarily open the primary packaging (Pp) for reading.

The codes (C1) and (C2) linked to an article (A) are informed in the application interface and compared by the computer program with the codes stored in the database (BD1) from the execution of a stored instruction in the computer program. When the pair of codes (C1) and (C2) is valid and is associated in the base (BD1), the codes (C1) and (C2) are linked to an entity (E).

If one of the attributes of the codes (C1) or (C2) presents nonconformities registered in the respective database (BD1), at the time of linkage of the article (A) to an entity (E), the computer program generates a alert. Examples of this occurrence are related to non-conformity of the batch or expiration date. In this situation, the user responsible for registration is prevented from continuing the operation.

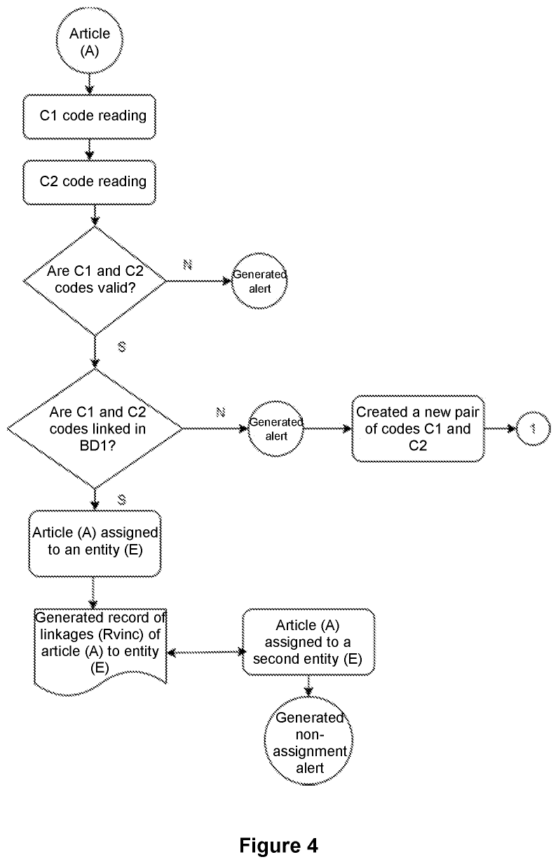

If the item (A) is assigned to an entity (E), a linkage record (Rvinc) is generated, stored in a database associated with the BD1 database, as shown in FIG. 4.

“n” articles (A) can be associated to an entity (E).

The attempt to associate an article (A) to a second entity (E2) is prevented based on the record of linkages (Rvinc), and the continuity of the operation is prevented. In this situation, a non-assignment alert message may be returned.

Optionally, a linkage record (Rvinc) to an entity (E) may require additional data information in specific articles (A) previously indicated in the database (BD1). For example, if the article (A) is implementable, the record of linkage (Rvinc) to an entity (E) is only closed with the record of the status of the article (A) implemented, opened or discarded.

Optionally, databases (DB) and their linkages are registered in Blockchain, allowing for traceability and inability to change.

Patient-related information is encrypted to maintain confidentiality.

The platform (P) allows the generation of management reports, making it possible to obtain information about articles assigned to a given patient, allowing data to be audited and preventing fraud and reuse of articles.

In case articles (A) are reusable, the number of uses can be controlled. In this situation, article (A) receives a code C1 with a control field defining a limit number of linkages. In this way, article A can be assigned to n entities (En) until reaching the maximum limit of linkages allowed on the platform, as shown in FIG. 6.

Optionally, a commercial adhesive code can be linked to article (A) only in the first reprocessing cycle.

1. Method implemented in a computer program to verify the conformity and/or authenticity of an article characterized by comprising:
a) generating random codes (C1) and (C2) using an algorithm;
b) assigning a pair of distinct random codes (C1 and C2) to an article (A);
c) linking codes C1 and C2 and article (A), in one-to-one correspondence, in a BD1 database accessed remotely through the world wide web;
d) inserting the first code (C1) inside the primary packaging (Pp) that houses the item (A) and kept inaccessible to human vision or to reading by a reader device;
e) second code (C2) kept apparent on the outside of the final packaging of the article (A);
f) pair of codes (C1) and (C2) linked to an article (A) is entered in an application;
g) if the pair of codes C1 and C2 is valid and the linkage is verified in the BD1 database, a message is returned in the application interface informing the compliance or authenticity status of the article (A);
h) if pair of codes is not valid and/or if the linkage of codes C1 and C2 is not verified in the BD1 database, an error message is returned.

2. Method according to claim 1, characterized in that a first code (C1) is generated by means of a proprietary computer program and a second code (C2) is generated by means of a commercial computer program.

3. Method according to claim 1, characterized in that the first code (C1) is printed/written on an avatar (B).

4. Method according to claim 3, characterized in that (B) is covered with scratchable paint.

5. Method according to claim 1, characterized in that the first code (C1) is printed/engraved on the surface of the article (A)).

6. Method according to claim 1, characterized in that the second code (C2) is printed/engraved on an avatar (B).

7. Method, according to claim 1, characterized in that more than one first code (C1) arranged inside a primary packaging (Pp) is linked to a second code C2 that contains a linked attribute that allows controlling the primary codes C1 linked to C2.

8. Method, according to claim 1, characterized in that any of the codes C1 or C2 has linked attributes verified by the computer program at the time of linkage analysis.

9. Method implemented in a computer program to verify the conformity and/or authenticity of an article characterized by comprising:
a) generating a primary random code (C1);
b) assigning code C1 to an article (A) and registration in database BD1;
c) inserting the first code (C1) inside the primary packaging (Pp) that houses the item (A) and kept inaccessible to human vision or to reading by a reader device;
d) primary code (C1) linked to an article (A) is entered in an application;
e) if code C1 is valid, after verifying the database (BD1), a message is returned in the application interface informing the compliance or authenticity status of the article (A);
f) if code C1 is not valid, after verifying the database (BD1), an error message is returned.

10. Method according to claim 1, characterized by comprising:
a) pair of valid and associated codes C1 and C2 in base BD1 are linked to an entity (E);
b) a linkage record (Rvinc) stored in a database associated with the database (BD1) is generated.

11. Method, according to claim 10, characterized in that the record of linkage (Rvinc) to an entity (E) requires additional data information in specific articles (A) previously indicated in the database (BD1).

12. Method, according to claim 9, characterized in that the primary code (C1) presents a control field defining a limit number of linkages, allowing the assignment to n entities (En) until reaching the maximum limit of linkages allowed on the platform.

13. Method, according to claim 1, characterized in that the primary code (C1) presents a control field defining a limit number of linkages, allowing the assignment to n entities (En) until reaching the maximum limit of linkages allowed on the platform.
